(19) United States
(12) Patent Application Publication
(10) Pub. No.: US 2008/0137383 A1
(43) Pub. Date: Jun. 12, 2008

(54) Two-phase power converter apparatus and method

(75) Inventors: Liuchen Chang, Fredericton (CA); Zhenhong Guo, Fredericton (CA)

Correspondence Address: STIKEMAN ELLIOTT LLP, 1600-50 O''CONNOR STREET, OTTAWA, ON, KIP 6L2, omitted

(73) Assignee: University of New Brunsick

(21) Appl. No.: 11/602,248

(22) Filed: Nov. 21, 2006

(51) Int. Cl. H02M 5/451

(52) U.S. Cl. 363/37

(57) ABSTRACT

A power conversion apparatus and method suitable for use with a variable speed two-phase generator are disclosed herein. A rectifier module is adapted to receive varying electrical power from a generator and produce a direct current link voltage with a controlled magnitude at a direct current link; and an inverter module is adapted to receive the direct current link voltage from the rectifier module via the direct current link and produce an alternating current voltage; the rectifier module comprises symmetrical circuit topologies thereby eliminating vibration and noise which may come from the generator. One rectifier module disclosed includes a circuit which is substantially of the class of circuits having two or more diodes operating in combination wherein one or more diodes have been replaced with one or more switching devices, rendering the rectifier controllable by Pulse Width Modulation. Another rectifier module disclosed includes a switching device, coupling first and second rectifiers to the generator, thereby enabling the direct current link voltage to be selectively equal to the voltage at one of the first and second rectifier direct current link voltages respectively. The need for a DC-Boost chopper is eliminated by using the inductance of the PMSG to store energy.

### CROSS-REFERENCE TO RELATED APPLICATIONS

This is the first application filed for the present invention.

### MICROFICHE APPENDIX

Not applicable.

### TECHNICAL FIELD

This application relates to power conversion techniques in general, and to a two-phase power converter apparatus and method, in particular.

### BACKGROUND OF THE INVENTION

As a source of environmentally friendly energy, wind energy is drawing much attention. More and more wind turbine generation systems have been installed all over the world to pursue social, environmental and economical benefits. The same can be said of hydro or water turbine generation systems.

From the application point of view, there are two kinds of turbine generation systems: one is the grid-connected turbine generation system, and the other is the standalone turbine generation system. From both the economical and scientific views, the grid-connected turbine systems are developed and applied broadly. Currently, the majority of wind turbine generation systems with high power capacity are connected to electric grids.

Various kinds of generators can be employed in turbine generation systems. Induction generators, DC-excited synchronous generators and permanent magnet synchronous generators (PMSG) are three kinds of generators commonly used in turbine generation systems. Induction generators are usually used in grid-connected systems and the capacity of the systems ranges from medium to high. The capacity of a DC-excited synchronous generator is usually very high. PMSGs are usually used in small to medium turbine generation systems, although recent developments have pushed PMSG generation systems into high power levels by some turbine generation system manufacturers.

One problem with PMSGs generally is that, although they may be well suited for direct-drive variable speed distributed generators such as small wind turbines and small hydro systems or water turbines, their conventional three-phase structure often results in large size and thus high cost due mainly to the mechanical constraints of the minimum tooth/slot pitch, large number of stator slots, and the large number of poles (typically over 60 poles) needed for low speed operation.

Another problem with power converter systems generally is that they require numerous power semiconductor devices, which may lead to higher cost and losses, and lower reliability. Furthermore, typical power converter systems include a DC boost chopper to boost the DC-link voltage, which requires an inductor to store energy. This may lead to increased cost and unpleasant acoustic noise.

Canadian Patent Application No. 2,269,255 discloses various configurations of a double-voltage bridge rectifier for use with either single-phase or three-phase turbine power generator conversion systems to feed either single-phase or three-phase loads, without using a DC boost chopper. The disclosed double-voltage bridge rectifiers are applied in combination with an Insulated Gate Bipolar Transistor (IGBT) inverter supplied by a variable ac voltage source to provide power to a fixed-voltage grid or load. The disclosed double-voltage bridge rectifiers include a switch which selects between two configurations depending on the strength of the voltage generated by the generator or source. The double-voltage bridge rectifier improves the energy output of the system to the grid or load by producing a sufficiently high dc link voltage to sustain the normal operation of the transistor-based inverter at both low and high source voltages. At a low source voltage, the bridge rectifier is configured into a double voltage rectifier with a dc link voltage approximately double that of a conventional bridge rectifier. At a high source voltage, the bridge rectifier is configured into a conventional bridge rectifier to provide a sufficient and appropriate dc link voltage to a transistor-based inverter. The supply ac voltage source is disclosed to be either a single-phase or a three-phase ac supply. The transistor-based inverter is disclosed to be either a single-phase or a three-phase inverter. The output of the inverter is disclosed to be either a single-phase or a three-phase grid or load. The disclosed application is an energy conversion system supplied by variable speed wind turbines with ac generators.

One problem with the double-voltage bridge rectifiers disclosed in Canadian Patent Application No. 2,269,255 is that when a generator is used in conjunction with the circuit topologies disclosed therein a vibration and noise may come from the generator.

### SUMMARY

According to one aspect of the present invention, there is provided a power conversion apparatus suitable for use with a variable speed two-phase generator, the apparatus comprising: (a) a rectifier module adapted to receive varying electrical power from the generator and produce a direct current link voltage at a direct current link; and (b) an inverter module adapted to receive the direct current link voltage from said rectifier module via the direct current link and produce an alternating current voltage; wherein the rectifier module comprises symmetrical circuit topologies thereby eliminating vibration and noise which may come from the generator.

According to another aspect of the present invention, there is provided a power conversion apparatus of the class where a variable speed two-phase permanent magnet synchronous generator (PMSG) provides power to a rectifier having two or more diodes operating in combination to produce a direct current link voltage, the direct current link voltage provided to an inverter to produce an AC voltage, wherein the improvement comprises replacing at least one of the two or more diodes of the rectifier with at least one switching device.

According to yet another aspect of the present invention, there is provided a method of providing a rectifier module apparatus suitable for use with a variable speed two-phase generator, the method comprising the steps of: (a) providing a rectifier having at least one diode; and (b) replacing at least one of the diodes of the rectifier with at least one switching device.

Other aspects and features of the present invention will become apparent to those ordinarily skilled in the art upon review of the following description of specific embodiments of a two-phase power converter apparatus and method in conjunction with the accompanying drawing figures.

### BRIEF DESCRIPTION OF THE DRAWINGS

Embodiments of the present invention will now be described, by way of example only, with reference to the accompanying drawing figures, wherein:

FIG. 1 is a block diagram of an uncontrolled embodiment of a two-phase power converter apparatus provided in accordance with the present invention;

FIG. 2 is a block diagram of a line-voltage bridge embodiment of an uncontrolled two-phase rectifier provided in accordance with the present invention;

FIG. 3 is a block diagram of a two-phase bridge embodiment of an uncontrolled two-phase rectifier provided in accordance with the present invention;

FIG. 4 is a block diagram of a boost voltage embodiment of an uncontrolled two-phase rectifier provided in accordance with the present invention;

FIG. 5 is a block diagram of a double voltage embodiment of an uncontrolled two-phase rectifier provided in accordance with the present invention;

FIG. 6 is a block diagram of an uncontrolled double-voltage embodiment of a two-phase power converter apparatus provided in accordance with the present invention;

FIG. 7 is a block diagram of a PWM controllable embodiment of a two-phase power converter apparatus provided in accordance with the present invention;

FIG. 8 is a flowchart of an embodiment of a two-phase power converter method provided in accordance with the present invention;

FIG. 9 is a block diagram of a line-voltage bridge embodiment of a PWM controllable two-phase boost rectifier provided in accordance with the present invention;

FIG. 10 is a block diagram of a first double-voltage embodiment of a PWM controllable two-phase boost rectifier provided in accordance with the present invention;

FIG. 11 is a block diagram of a second double-voltage embodiment of a PWM controllable two-phase boost rectifier provided in accordance with the present invention;

FIG. 12 is a block diagram of a two-phase bridge embodiment of a PWM controllable two-phase boost rectifier provided in accordance with the present invention; and

FIG. 13 is a block diagram of a switchable double-voltage embodiment of a PWM controllable two-phase boost rectifier provided in accordance with the present invention.

Like reference numerals are used in different figures to denote similar elements.

### DETAILED DESCRIPTION OF THE DRAWINGS

Advantageously, embodiments of two-phase power converter apparatus and method described herein enhance power extraction from turbines, feed high quality power to a grid or load, use fewer power devices than are typical in the art, enable the use of smaller and lighter two-phase generators, and eliminate vibration that may come from the generator. The structure and/or steps of the embodiments of two-phase power converter apparatus and method enable these and other advantages.

Although various types of generators are contemplated, PMSGs are preferred as they have many advantages over other kinds of generators when used with two-phase power converter apparatus and method. PMSGs employ permanent magnets to excite the generator magnetic system, thus eliminating the exciting systems found in the DC-excited synchronous generators. When high performance magnets are more commonly used, it is anticipated that PMSGs will become compact and lead to a high ratio of power/volume. Compared to induction generators, since PMSGs supply excitation by permanent magnets and need not draw reactive power from the grid or load, the power factor of PMSGs can be very high.

The main objective of a power converter system is to achieve the maximum power extraction from turbines and feed high quality power to the grid or load. For this reason, both the structure of the power converter apparatus as well as control methods are to be given consideration in the design of converter systems.

Embodiments of methods which maximize power extraction are contemplated to utilize several known algorithms: fuzzy control algorithm, improved pulse width modulation (PWM) technique, and neutral network control algorithm etc., are known and contemplated to operate in combination with embodiments of the two-phase power converter apparatus and method described herein. These algorithms have shown significant improvements on the extraction of power from turbine-generator systems in some applications.

The control algorithm that determines the output current references based on the DC-link voltage still dominates converter applications, because of its simplicity, reliability and practicality. Consequently, preferred embodiments of the two-phase power converter apparatus and method determine the output current references based on the DC-link voltage Vdc. The bigger the Vdc, the more power can be extracted at low turbine speeds. To obtain higher Vdc, several topologies are contemplated in alternative embodiments, all of which at least depart from convention by being optimized to utilize two-phase generators as opposed to the three-phase generators typical in the art.

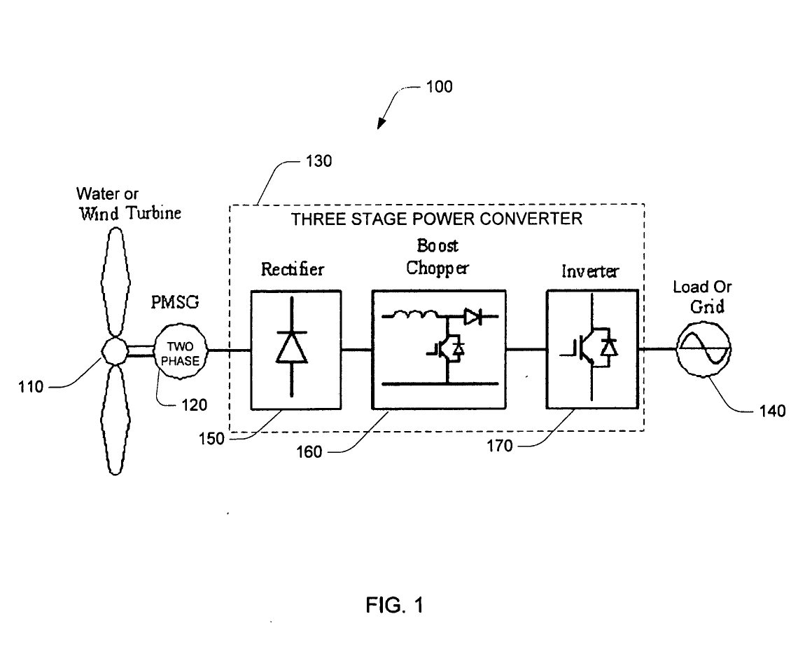

Referring now to the drawings, FIG. 1 is a block diagram of an uncontrolled embodiment of a two-phase power converter apparatus provided in accordance with the present invention. The converter system 100 of FIG. 1 includes a wind or water turbine 110 which extracts power from wind or water to drive a two-phase PMSG 120 which generates electricity. A three-stage power converter 130 is used in order to extract power from the electricity generated by the PMSG. The three-stage power converter 130 includes a rectifier 150 at its input, an inverter 170 at its output, and an optional DC boost chopper 160 between the output of the rectifier and the inverter. The optional DC boost chopper is only needed if the rectifier cannot by itself achieve a sufficiently high DC-link voltage. The output of the three-stage power converter 130 feeds power to an electrical load or grid 140.

The three-stage power converter 130 uses a two-phase rectifier 150 configured to inter-operate with the two-phase PMSG 120. Advantageously, the use of a two-phase PMSG 120 in combination with the two-phase rectifier 150 eliminates vibration and noise which may come from the generator because of the symmetry of the circuit topologies possible with a two-phase system.

Further advantageously, since the number of stator teeth/slots of a two-phase PMSG 120 is only ⅔ of that of a three-phase PMSG at the same rated operating speed, the problem of minimum tooth/slot pitch constraint is much alleviated, resulting in a smaller diameter of the generator, thus smaller size, weight and lower costs in comparison to a three-phase PMSG.

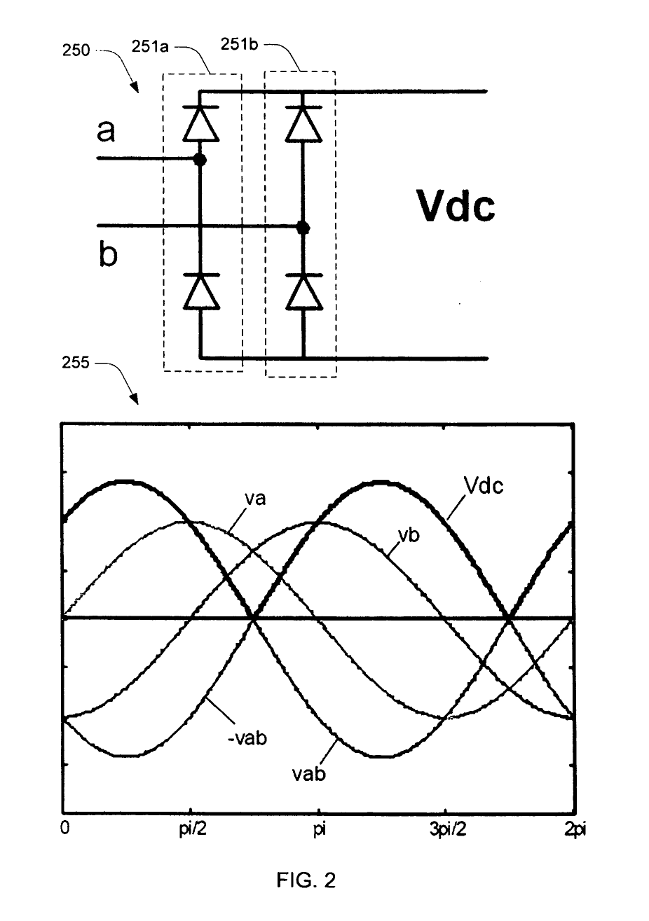

When the generated voltage of the PMSG 120 varies at variable speeds caused by variable water or wind turbine 110 speed, it is contemplated that the dc voltage can be controlled by switching between different two-phase topologies within rectifier 150. FIGS. 2-5 show in detail exemplary embodiments of two-phase rectifiers, as well as their associated waveforms and output voltages, which are contemplated to be suitable for use either alone or in combination within rectifier 150 of FIG. 1.

FIG. 2 is a block diagram of a line-voltage bridge embodiment of an uncontrolled two-phase rectifier provided in accordance with the present invention. The line-voltage bridge rectifier 250 includes two dual diode modules 251a, 251b connected in parallel or a full bridge quad diode module. At high turbine speeds, the line-voltage bridge rectifier 250 in FIG. 2 is used to produce a lower dc voltage which is sufficient for inverter operation, thus alleviating over-voltage problems. The four diode topology of the line-voltage bridge rectifier 250 uses the a and b line terminals of the 2-phase PMSG 120 of FIG. 1 connected between the diodes of each of the two dual diode modules 251a, 251b respectively. The output voltage waveforms 255 of the line-voltage bridge rectifier 250 (Vdc), and of the a and b line terminals (va, vb) of the 2-phase PMSG 120 of FIG. 1, are shown under no-load condition. The average output voltage of the line-voltage bridge rectifier 250 is

$${V}_{dc} = \frac{2}{π} {V}_{l} ,$$

where Vₗ is the rms value of line-line voltage of the PMSG 120.

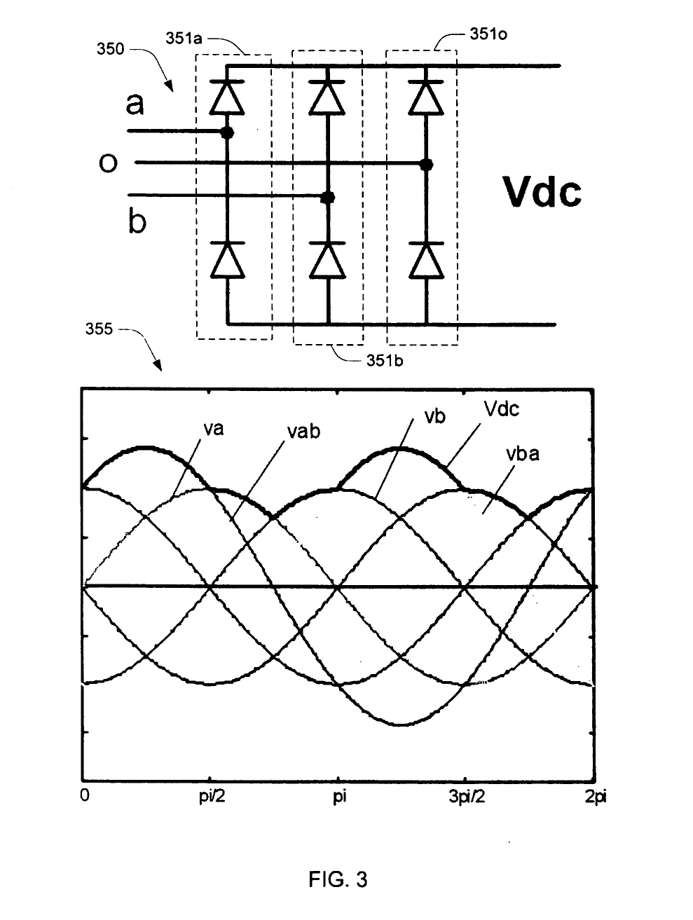

FIG. 3 is a block diagram of a two-phase bridge embodiment of an uncontrolled two-phase rectifier provided in accordance with the present invention. The two-phase bridge rectifier 350 includes three dual diode modules 351a, 351b, and 351o or a hex diode module. At medium turbine speeds, the two-phase bridge topology in FIG. 3 produces a medium DC-link voltage level. The six diode topology of the two-phase bridge rectifier 350 uses the a and b line terminals as well as the neutral o terminal of the 2-phase PMSG 120 of FIG. 1 connected between the diodes of each of the three dual diode modules 351a, 351b and 351o respectively. The output voltage waveforms 355 of the two-phase bridge rectifier 350 (Vdc), of the a and b line terminals (va, vb) of the 2-phase PMSG 120, and of the difference in voltage between the a and b line terminals (vab, vba), are shown under no-load condition. The average output voltage of the two-phase bridge rectifier 350 is

$${V}_{dc} = \frac{2 + \sqrt{2}}{π} {V}_{l} ,$$

where Vₗ is the rms value of line-line voltage of the PMSG 120.

Comparing the average output voltage of two-phase bridge rectifier 350 with the line-voltage bridge rectifier 250, the output of the two-phase bridge rectifier is higher. Therefore, to get a higher DC-link voltage and extract more power from the wind or water turbine generator, it is preferable that the neutral point o of the 2-phase PMSG 120 of FIG. 1 should be utilized.

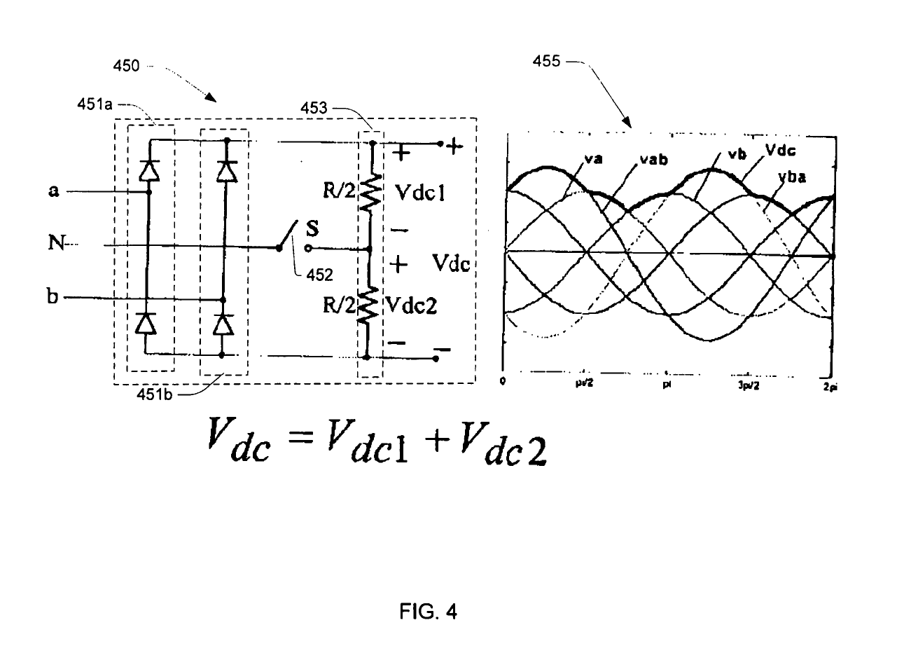

FIG. 4 is a block diagram of a boost voltage embodiment of an uncontrolled two-phase rectifier provided in accordance with the present invention. The boost voltage embodiment of FIG. 4 includes two dual diode modules 451a, 451b, a switch “S” 452, which can be an electromagnetic contactor or other suitable switching device, and a dual resistor module 453. At low turbine speeds, with corresponding low generator electrical power, the boost voltage topology 450 in FIG. 4 when switch “S” 452 is closed to connect the neutral terminal N of the PMSG between the R/2 resistors of the dual resistor module 453. In this fashion, the boost voltage topology 450 is used as a boost voltage rectifier to produce a higher DC-link voltage to ensure the adequate power flow from the DC-link to the inverter, and ac load or grid. At sufficiently high turbine speeds, with correspondingly sufficiently high generator electrical power, switch “S” 452 is kept open to produce a lower DC voltage which is sufficient for inverter operation, thus alleviating over-voltage problems. The output voltage waveforms 455 of the two-phase bridge rectifier 450 (Vdc), of the a and b line terminals (va, vb) of the 2-phase PMSG 120, and of the difference in voltage between the a and b line terminals (vab, vba), are shown under no-load condition. The average output voltage of the boost voltage rectifier 450 is

$${V}_{dc} = {V}_{dc 1} + {V}_{dc 2} = \frac{2 \sqrt{2}}{π} {V}_{l}$$

when switch “S” 452 is closed, and

$${V}_{dc} = {V}_{dc 1} + {V}_{dc 2} = \frac{2}{π} {V}_{l}$$

when switch “S” 452 is open, where Vₗ is the rms value of line-line voltage of the PMSG 120 of FIG. 1.

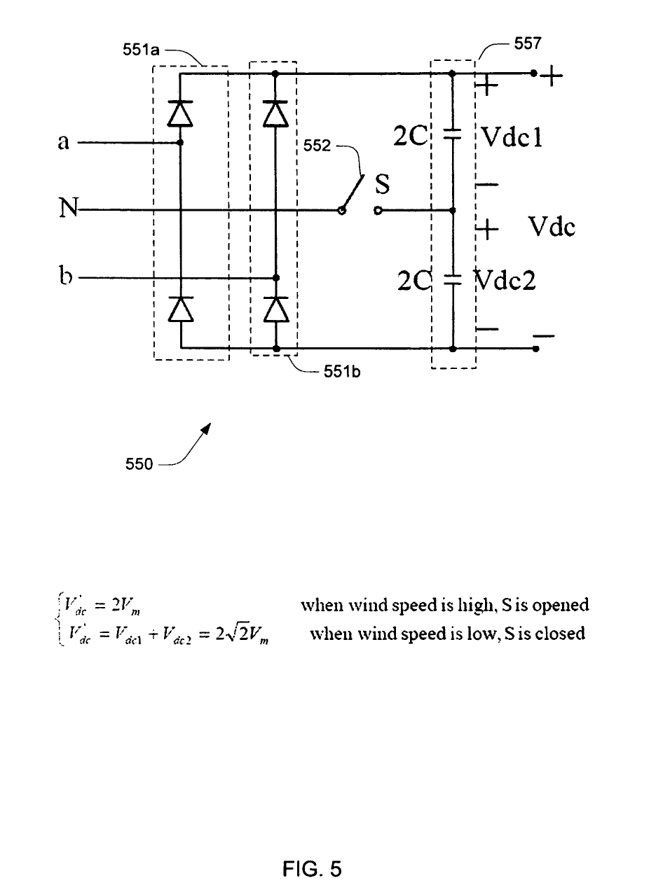

FIG. 5 is a block diagram of a double voltage embodiment of an uncontrolled two-phase rectifier provided in accordance with the present invention. The double voltage topology 550 includes two dual diode modules 551a, 551b, a switch “S” 552, and a dual capacitor module 557. At low turbine speeds, the double voltage topology 550 in FIG. 5 when switch “S” 552 is closed to connect the neutral terminal N of the PMSG between the 2C capacitors of the dual capacitor module 557. When used in this fashion the double voltage rectifier 550 produces a higher DC-link voltage to ensure the adequate power flow from the DC-link to the inverter, and ac grid or load. At sufficiently high turbine speeds, switch “S” 552 is kept open to produce a lower DC-link voltage which is sufficient for inverter operation, thus alleviating over-voltage problems. The DC-link voltage is √2 times of that of FIG. 2 and FIG. 3 when capacitor C 557 is sufficiently big. To coincide with the concept in a three-phase rectifier, the topology in FIG. 5 is nonetheless referred to as a two-phase double-voltage rectifier, even thought the DC-link voltage is improved √2 times.

The switch “S” 552 selectively couples the neutral line and the mid point of the bank capacitors 2C and when the switch is closed, the DC-link voltage will be V_{dc}=V_{dc1}+V_{dc2}=2\sqrt{2}Vₘ, where Vₘ is the rms value of phase voltage of the PMSG.

With the above described topologies of uncontrolled rectifiers, the DC-link voltage of the two-phase PMSG system can accommodate a wide range of input voltage or generator speed variations. Thus, if the two-phase PMSG converter system is used for small turbines, the operation range of turbines can be expanded and the power output at low to medium trubine speeds can be improved.

The switching of the two-phase PMSG rectifiers can simply be accomplished by an electromagnetic contactor such as the switch 452 shown in FIG. 4, thus ensuring the low-cost implementation of control strategies. Other switching devices, such as solid-state relays would be apparent to a person of ordinary skill in the art in view of the present disclosure.

The two-phase generator always maintains symmetrical operations between the two-phases despite variations in configuration of contemplated two-phase rectifiers, presenting an advantage over the three-phase generators which under analogous variations in configuration would suffer from unsymmetrical currents among the phases. Advantageously, this eliminates vibration and noise which may come from the generator.

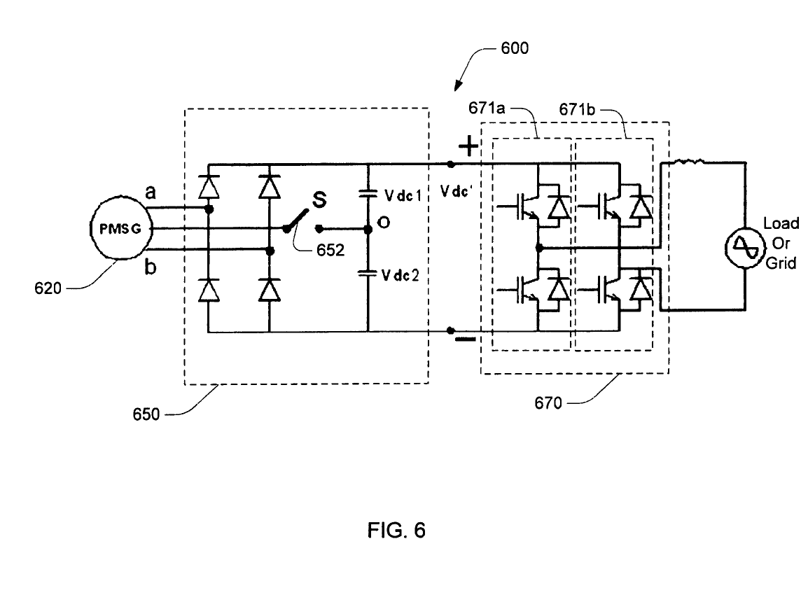

FIG. 6 is a block diagram of an uncontrolled double-voltage embodiment of a two-phase power converter apparatus provided in accordance with the present invention. In the system 600, the double voltage two-phase uncontrolled rectifier 650, employing the rectifier topology 550 of FIG. 5, is provided in combination with an Insulated Gate Bipolar Transistor (IGBT) inverter 670, and a switch “S” 652, thereby improving the output energy of the system. Details of the structure of a suitable two-phase IGBT inverter are shown, which includes two dual IGBT modules 671a, 671b connected in parallel.

Advantageously, this configuration does not require a DC boost chopper: the inductance which is used to store energy when the switch 652 in the rectifier is closed, is provided and determined solely by the PMSG 620. Using PMSG's 620 winding leakage inductance as the storage inductor eliminates the need for a separate inductor as was required in embodiments that use the DC-boost chopper; therefore, the cost can be advantageously reduced.

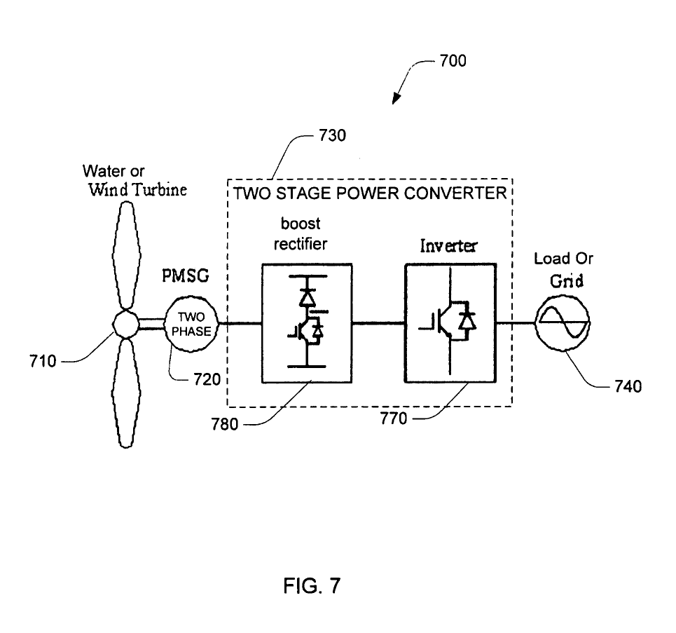

FIG. 7 is a block diagram of a PWM controllable embodiment of a two-phase power converter apparatus provided in accordance with the present invention. The converter system 700 of FIG. 7 includes a wind or water turbine 710 which extracts power from water or wind to drive a two-phase PMSG 720 which generates electricity. Advantageously, a two stage power converter 730 is used in order to extract power from the electricity generated by the PMSG. The two stage power converter 730 includes a boost rectifier 780 at its input, linked via a DC-link to an inverter 770 at its output. The output of the two stage power converter 730 feeds power to an electrical load or grid 740.

The boost rectifier advantageously integrates the function of the first two stages of the power converter 130 (i.e., rectifier 150 and boost chopper 160) of FIG. 1, and improves performance. In this regard, the double voltage rectifier 550 of FIG. 5, when used as in FIG. 6 as the rectifier 650 in the converter system 600, which does not include a DC boost chopper, is an embodiment of a boost rectifier provided in accordance with the present invention.

When the PMSG 720 is designed and manufactured, the inductance used to store energy cannot be varied. To overcome this limitation, in addition to the above proposed uncontrolled rectifiers, embodiments of Pulse Width Modulated (PWM) controllable two-phase rectifiers are contemplated and disclosed herein in accordance with the present invention to produce a regulated DC-link voltage for further performance enhancement to two-phase PMSG converter systems for variable speed turbine applications.

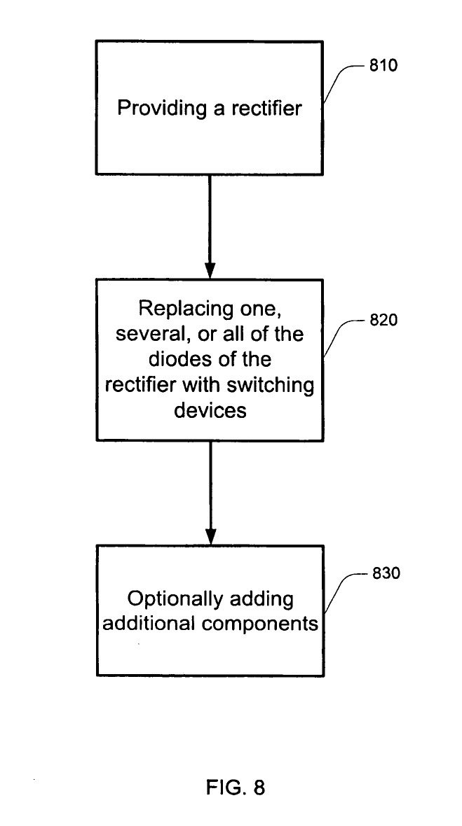

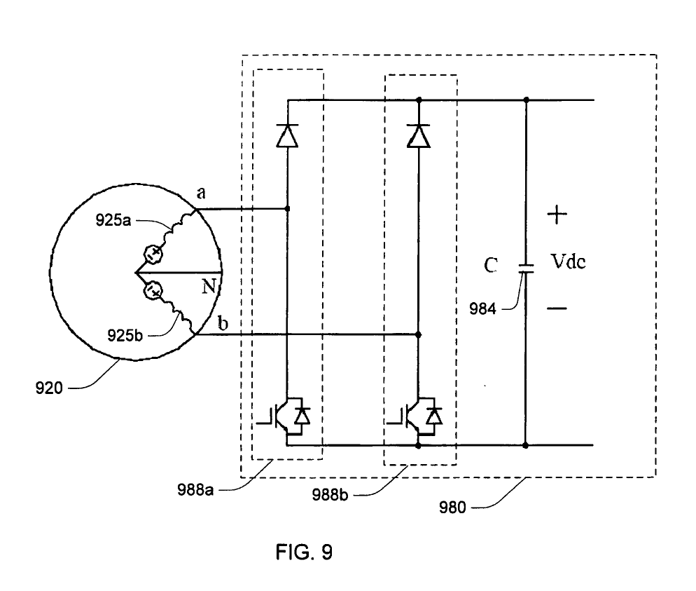

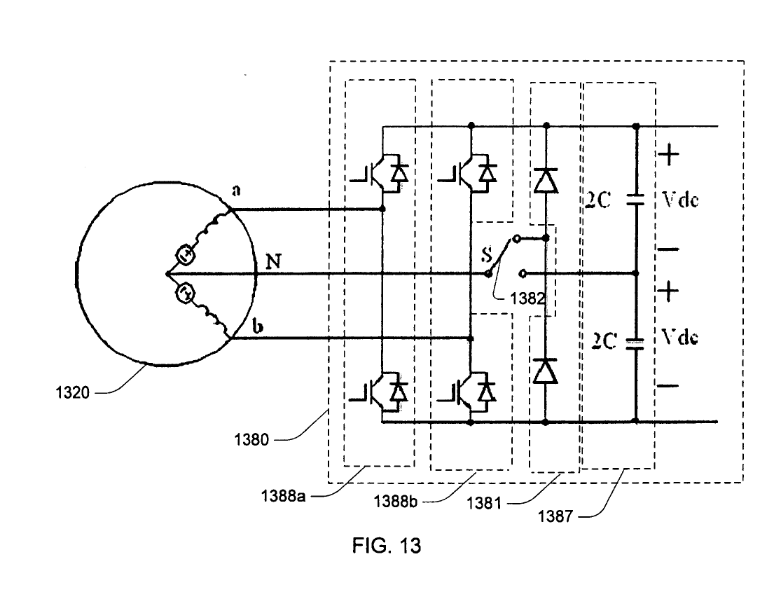

FIG. 8 is a flowchart of an embodiment of a two-phase power converter method provided in accordance with the present invention. At step 810, a rectifier is provided, such as but not limited to, any of the rectifiers in FIGS. 2-5. At step 820, one, several, or all of the diodes of the rectifier provided at step 810, are replaced with switching devices. At step 830, additional components may be added as required, such as but not limited to diodes, switching devices, resistors, capacitors and inductors. Contemplated exemplary embodiments, resulting from the application of the flowchart of FIG. 8 to the rectifiers shown in FIGS. 2, 5, 3, result in the exemplary embodiments of two-phase PWM controllable boost rectifiers shown in FIGS. 9, 10 and 11, and 12 respectively. A preferred embodiment of a two-phase PWM controllable boost rectifier is shown in FIG. 13.

The resulting two-phase PWM controllable boost rectifiers advantageously integrate the functions of the first two stages of the power converter 130 (i.e., rectifier 150 and boost chopper 160) in FIG. 1, and improve performance. It is contemplated that through suitable pulse width modulation control on the power switching devices in a boost rectifier, the energy is first stored in generator leakage inductance and the released DC-link, thus the DC-link voltage can be boosted. Furthermore, by employing suitable control algorithms such as current vector control algorithms, the power factor of the PMSG output can also be regulated as needed for controlling the air gap flux of the generator and thus for controlling the generated voltage. The flux produced by stator windings of the two phase generator can be controlled by the PWM rectifier, so that its space angle varies with respect to that of the space angle of the permanent magnets. Thus the air gap flux is regulated. The induced voltage in the stator windings is the controlled, resulting a controlled output voltage of the generator.

FIG. 9 is a block diagram of a line-voltage bridge embodiment of a PWM controllable two-phase boost rectifier provided in accordance with the present invention. Applying the method of FIG. 8 (step 820) to the rectifier provided in FIG. 2 (step 810) results in the exemplary two-phase PWM controllable boost rectifiers shown in FIG. 9. The “Line-Voltage Bridge Topology” of the PWM controllable boost rectifier 980 in FIG. 9 uses a small number of power devices (only 2 IGBTs and 2 diodes). The line voltage bridge two-phase PWM controllable boost rectifier 920 includes two single-diode single-IGBT modules 988a, 988b and a capacitor “C” 984 connected in parallel. The line voltage bridge two-phase PWM controllable boost rectifier 980 uses the a and b line terminals of the 2-phase PMSG 980 connected between the diode and IGBT of each of the two single-diode single-IGBT modules 988a, 988b respectively. Each of the two single-diode single IGBT modules 988a, 988b correspond to (step 820) dual diode modules 251a and 251b respectively wherein the diodes in the lower branches have been substituted with switching devices, specifically IGBTs.

Advantageously, the line voltage bridge two-phase PWM controllable boost rectifier 980 uses the leakage inductance 925a, 925b inherent in the PMSG 920 to store energy when the IGBT switch in.

However, the range of voltage boost achievable by the line voltage bridge two-phase PWM controllable boost rectifier 980 may be limited due to the fact that it only uses two power devices. Using additional power devices would increase the voltage boost. Depending on the requirements of a specific application, an appropriate trade-off between number of power devices and voltage boost can be achieved in view of the present specification.

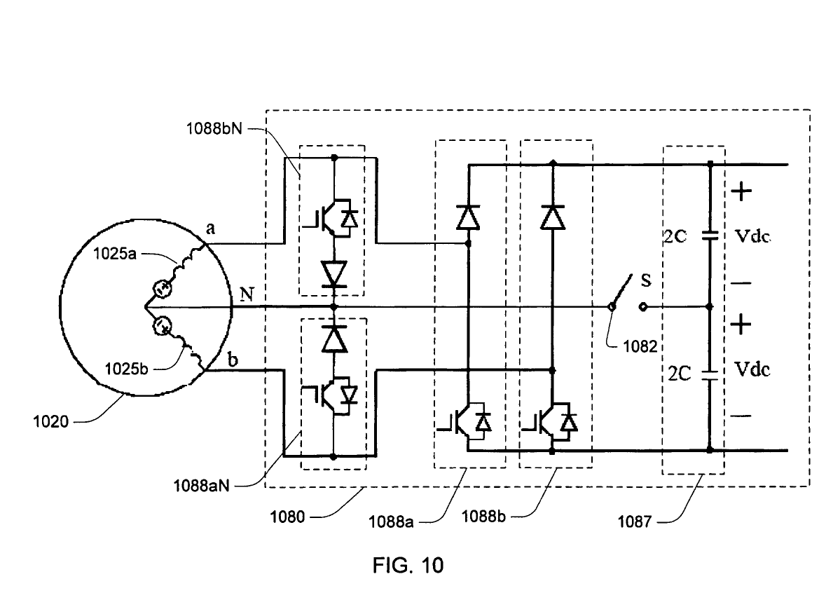

FIG. 10 is a block diagram of a first double-voltage embodiment of a PWM controllable two-phase boost rectifier provided in accordance with the present invention. Applying the method of FIG. 8 (step 820) to the rectifier provided in FIG. 5 (step 810) results in the exemplary two-phase PWM controllable boost rectifier shown in FIG. 10. The double voltage two-phase PWM controllable boost rectifier 1080 includes two single-diode single IGBT modules 1088a, 1088b and a double capacitor “2C” module 1087 connected in parallel, and a switch “S” 1082 connected between them, which are analogous to (step 820) the two dual diode modules 551a, 551b, the dual capacitor module 557, and switch “S” 552 of FIG. 5 respectively. The double voltage two-phase PWM controllable boost rectifier 1080 uses the a, b and N line terminals of the 2-phase PMSG 1020 connected between the diode and IGBT of each of the two single-diode single-IGBT modules 1088a, 1088b, and switch “S” 1082 respectively. Furthermore, two additional single IGBT diode modules 1088aN, 1088bN are provided (step 830) between the a and N terminals, as well as the b and N terminals respectively of PMSG 1020. The “Double-voltage Topology” of the two-phase PWM controllable two-phase boost rectifier 1080 in FIG. 10 has the advantages of both a boost rectifier as well as a “double voltage” uncontrolled boost rectifier of FIG. 5, with the possibility of more sophisticated control algorithm, i.e. with the possibility of control of more switches, by adding a few additional power devices, notably the two IGBTs in the two single IGBT diode modules 1085aN, 1085bN.

Advantageously, the double voltage two-phase PWM controllable boost rectifier 1080 uses the inductance 1025a, 1025b inherent in the PMSG 1020 to store energy when either of the controllable switches, i.e. either of the IGBTs is closed.

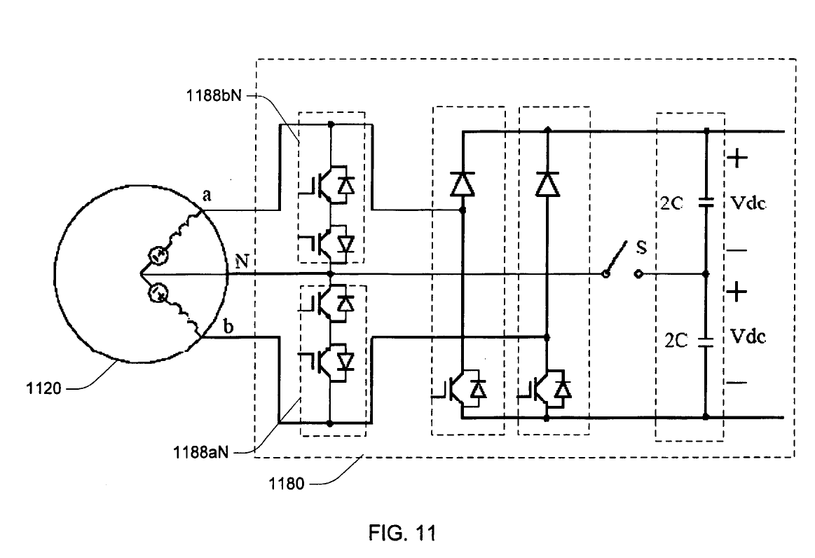

FIG. 11 is a block diagram of a second double-voltage embodiment of a PWM controllable two-phase boost rectifier provided in accordance with the present invention. The “Double-voltage Topology” of the PWM boost rectifier in FIG. 11 can be used as a boost rectifier as well as a “double voltage” with a similar feature of an uncontrolled boost rectifier of FIG. 5, with more sophisticated control algorithms and additional power devices. As compared to the embodiment of FIG. 10, the double voltage PWM boost rectifier 1180 includes two dual IGBT modules 1188aN, 1188bN which are provided (step 830) instead of the two single IGBT diode modules 1088aN, 1088bN of FIG. 10. This enables more controllability on the output voltage of the rectifier.

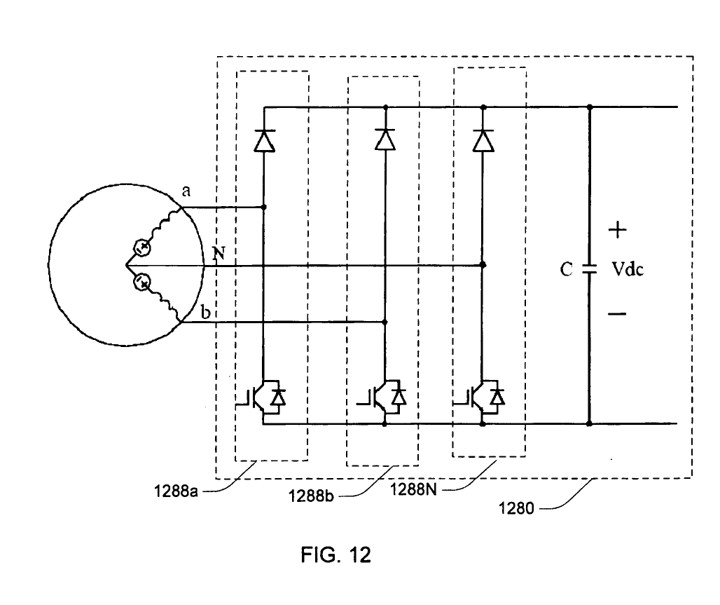

FIG. 12 is a block diagram of a two-phase bridge embodiment of a PWM controllable two-phase boost rectifier provided in accordance with the present invention. The “Two-Phase Bridge Topology” of the PWM boost rectifier in FIG. 12 provides a more flexible control than the Line-Voltage Bridge Topology in FIG. 9, but cannot realize the “double-voltage” function of the rectifier in FIG. 9. Applying the method of FIG. 8 (step 820) to the rectifier provided in FIG. 3 (step 810) results in the exemplary two-phase PWM controllable boost rectifier 1280 presented in FIG. 12, wherein dual diode modules 351a, 351b, 351o of the two phase bridge rectifier 350 find correspondence with (step 820) analogous single IGBT diode modules 1288a, 1288b, 1288N respectively. Therefore, a PWM boost rectifier topology is formed. Advantageously, a DC boost chopper is not needed.

FIG. 13 is a block diagram of a switchable double-voltage embodiment of a PWM controllable two-phase boost rectifier provided in accordance with the present invention. FIG. 13 shows the “Switchable Double-Voltage Topology” of PWM boost rectifier 1380, where two dual IGBT modules 1388a, 1388b, one dual diode module 1381, a dual capacitor module 1387, and a switch 1382 are used to construct the boost rectifier. Although not expressly shown in the drawings, in an alternative embodiment, if only the boost function of the rectifier 1380 is desired, the upper devices in the two dual IGBT modules 1388a, 1388b can be replaced with single diodes.

Operationally, the control of the switch “S” 1382 in FIG. 13 is as follows: when the output voltage of the two-phase PMSG 1320 is low such as in the case of the low wind speed for a wind turbine, or low water flow for a water turbine, switch “S” 1382 is controlled so that the neutral line of the PMSG 1320 is connected to the mid-point of the dc-link capacitors of the dual capacitor module 1387, therefore, the DC-link voltage is “doubled”, meanwhile, the IGBTs in the lower arms of the two dual IGBT modules 1388a, 1388b of the rectifier are controlled to further “boost” the dc-link voltage; when the output voltage of the two-phase PMSG 1320 is high, in order to protect the converter system, switch “S” is turned so that the neutral line of the two-phase PMSG 1320 is connected to the mid-point of the dual diode module 1381, and also, the control of the IGBTs in the dual IGBT modules 1388a, 1388b of the rectifier may be stopped, and the power devices in the lower arms of the dual IGBT modules 1388a, 1388b operate only as diodes.

Advantageously, the present power conversion system when applied for variable speed small distributed generators such as wind turbines and small hydro systems will increase the energy output and, at the same time, will reduce the cost and size of the direct-drive generator.

In alternative embodiments, it is contemplated that various kinds of generators can be employed. Induction generators, DC-excited synchronous generators and permanent magnet synchronous generators (PMSG) are three kinds of generators commonly used in wind turbine generation systems. Induction generators are usually used in grid-connected systems and the capacity of the systems ranges from medium to high. DC-excited synchronous generators' capacity is usually very high. PMSGs are usually used in small to medium wind turbine generation systems, although recent developments have pushed PMSG generation systems into high power levels by some wind turbine generation system manufacturers.

In alternative embodiments, a transistor based inverter is utilized. Examples of transistors suitable for use in transistor based inverters are IGBTs, MOSFETs, or other suitable transistor device as would be obvious to a person of ordinary skill in the art.

The above-described embodiments of the present invention are intended to be examples only. Those of skill in the art may effect alterations, modifications and variations to the particular embodiments without departing from the scope of the invention, which is set forth in the claims.

What is claimed is:

1. A power conversion apparatus suitable for use with a variable speed two-phase generator, the apparatus comprising:
(a) a rectifier module adapted to receive varying electrical power from the generator and produce a direct current link voltage at a direct current link; and
(b) an inverter module adapted to receive the direct current link voltage from said rectifier module via the direct current link and produce an alternating current voltage;
wherein the rectifier module comprises symmetrical circuit topologies thereby eliminating vibration and noise which may come from the generator.

2. The apparatus as recited in claim 1, wherein the rectifier module further comprises a circuit which is substantially of the class of circuits having two or more diodes operating in combination wherein one or more diodes have been replaced with one or more switching devices.

3. The apparatus as recited in claim 2, wherein the one or more switching devices are operated to boost the direct current link voltage.

4. The apparatus as recited in claim 2, wherein the generator is a permanent magnet synchronous generator (PMSG) and wherein the one or more switching devices are operated so as to regulate the power factor of the PMSG output for controlling the air gap flux of the generator to control a generated voltage.

5. The apparatus as recited in claim 2, wherein the rectifier module comprises at least one rectifier selected from the group comprising line voltage bridge rectifier, double voltage rectifier, two-phase bridge rectifier, and switchable double-voltage rectifier.

6. The apparatus as recited in claim 1, wherein the rectifier module further comprises:
(a) a first rectifier suitable for producing a first direct current link voltage from the varying electrical power;
(b) a second rectifier suitable for producing a second direct current link voltage from the varying electrical power, the second direct current link voltage being substantially greater than the first direct current link voltage; and
(c) a switching device, coupling one of the first and second rectifiers to the generator, thereby enabling the direct current link voltage to be selectively equal to one of the first and second direct current link voltages respectively.

7. The apparatus as recited in claim 6, wherein said switching device is operated to couple the first rectifier to the generator to lower the direct current link voltage to a value which is sufficient for inverter operation, thereby alleviating over-voltage problems at high generator speeds.

8. The apparatus as recited in claim 6, wherein said switching device is operated to couple the second rectifier to the generator to increase direct current link voltage to a value which ensures adequate power flow from the direct current link to the inverter at low to medium generator speeds.

9. The apparatus as recited in claim 6, wherein at least one of the first and second rectifiers is selected from the group comprising line voltage bridge rectifier, double voltage rectifier, two-phase bridge rectifier, and switchable double-voltage rectifier.

10. The apparatus as recited in claim 1, wherein the generator is a permanent magnet synchronous generator (PMSG).

11. The apparatus as recited in claim 10, wherein the rectifier module comprises at least one switching device, and wherein the winding inductance of the generator is used to store energy when the switching device in the rectifier module is closed.

12. The apparatus as recited in claim 1, wherein the generator extracts power from a wind turbine.

13. The apparatus as recited in claim 1, wherein the generator extracts power from a water turbine.

14. The apparatus as recited in claim 1, wherein said inverter is a transistor based inverter.

15. The apparatus as recited in claim 14, wherein said inverter is an IGBT based inverter.

16. The apparatus as recited in claim 14, wherein said inverter is a MOSFET based inverter.

17. The apparatus as recited in claim 1, wherein said rectifier module is an un-controlled rectifier module.

18. The apparatus as recited in claim 1, wherein said rectifier module is a pulse width modulated (PWM) controlled rectifier module.

19. A power conversion apparatus of the class where a variable speed two-phase permanent magnet synchronous generator (PMSG) provides power to a rectifier having two or more diodes operating in combination to produce a direct current link voltage, the direct current link voltage provided to an inverter to produce an AC voltage, wherein the improvement comprises replacing at least one of the two or more diodes of the rectifier with at least one switching device.

20. The apparatus as recited in claim 19, wherein the at least one switching device is operated to boost the direct current link voltage.

21. The apparatus as recited in claim 19, wherein the at least one switching device is operated so as to regulate the power factor of the PMSG output for controlling the air gap flux of the generator to control a generated voltage.

22. The apparatus as recited in claim 19, wherein the rectifier comprises one or more rectifiers selected from the group comprising line voltage bridge rectifier, double voltage rectifier, two-phase bridge rectifier, and switchable double-voltage rectifier.

23. The apparatus as recited in claim 19, wherein the rectifier has a symmetrical circuit topology thereby eliminating vibration and noise which may come from the generator.

24. The apparatus as recited in claim 19, wherein the winding inductance of the generator is used to store energy when the at least one switching device is closed.

25. A method of providing a rectifier module apparatus suitable for use with a variable speed two-phase generator, the method comprising the steps of:
(a) providing a rectifier having at least one diode; and
(b) replacing at least one of the diodes of the rectifier with at least one switching device.

26. The method as recited in claim 25, further comprising the step of adding additional diodes to the rectifier.

27. The method as recited in claim 25, further comprising the step of adding additional switching devices to the rectifier.

28. The method as recited in claim 25, further comprising the step of operating the at least one switching device to boost a direct current link voltage at the output of the rectifier.

29. The method as recited in claim 25, wherein the generator is a variable speed two-phase permanent magnet synchronous generator (PMSG), the method further comprising the step of operating the at least one switching device to regulate the power factor of the PMSG output for controlling the air gap flux of the generator to control a generated voltage.
